(19) United States
(12) Patent Application Publication
(10) Pub. No.: US 2009/0194142 A1
(43) Pub. Date: Aug. 6, 2009

(54) Two-Wheeled In-Line Walker

(76) Inventor: Paul James Zimmerman, San Jose, CA (US)

Correspondence Address: Paul J. Zimmerman, 6893 BURNSIDE DR., SAN JOSE, CA, 95120, US

(21) Appl. No.: 12/025,137

(22) Filed: Feb. 4, 2008

(51) Int. Cl. A61H 3/04; B60B 33/00

(52) U.S. Cl. 135/67; 16/47

(57) ABSTRACT

A supportive medical walking aid for indoor use consisting of two small caster wheels located in-line with adjustable, collapsible seat and handle bars. The invention is viewed as a long term lifestyle enhancing tool rather than a temporary rehabilitative or therapeutic device. Locomotion is provided only by a walking action of the infirmed person. The device is collapsible and light weight for easy transport and storage. Seat and handle bar placement geometry to facilitate comfortable walking, standing and forward leaning as in easy resting. Frame consisting of a front near vertical steering member with caster wheel rotatably attached; a rear member with caster wheel rotatably attached and a horizontal member vertically pivotally attached to the rear member and rotatably and releasably attached to the lower end of the front member. The adjustable, collapsible seat is attached to the rear member and the handlebar assembly is attached to the front member. A hinge connects the top of the rear member to the front member in a manner allowing rotation of the front steering member. Safety brakes are provided on both front and rear casters.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of the Invention

The present invention relates to walking aid devices and more particularly to a new walking aid device which allows the user to take most or all of the body weight off the lower extremities while in a standing position and allowing increased mobility through direct foot contact with the surface using a walking motion and is aimed at long term indoor use where surfaces are smooth and higher speed devices like bicycles are prohibited. While this invention may have rehabilitative and therapeutic value its primary intended use is by persons with chronic lower limb problems who wish to lead a more normal life style without corrective surgery.

2. Prior Art

The use of walking aid devices is known in the prior art. U.S. Pat. Nos. 6,318,392; 5,887,887 describe walking carts utilizing 2, 3 and 4 wheels to assist the user in walking without any substantial unloading of the lower extremities. These generally provide stabilization through hand holds and using the arms for support. The wheels are located on each side of the user and not in-line fore and aft. U.S. Pat. Nos. 5,800,317; 6,634,660; 7,287,767 describe walking carts utilizing 3 and 4 wheels for holding an injured leg while the user is walking with one leg. U.S. Pat. No. 6,450,516 describes a two wheeled scooter with foot platform and seat with large bicycle wheels designed for outdoor transport and exercise. U.S. Pat. No. 6,991,243 describes a 4 wheeled scooter utilizing small caster wheels with no seat for unloading the lower extremities. U.S. Pat. No. 6,474,667 describes a “Dandy Horse” which is a two-wheeled coaster with foot to surface propelled device with large wheels, fenders, lights and reflectors aimed at exercise, fitness, higher speeds and outdoor use. U.S. Pat. No. 6,149,170 describes a “Bike-like rehabilitation device” utilizing three wheels with the front two mounted transversely to provide steering and stabilization to the user. U.S. Pat. No. 5,167,597 describes a “treatment method” for ambulatory disease in humans including a four-wheeled stabilized walker to provide support during exercise therapy. U.S. Pat. Nos. 4,718,688; 6,986,522; et al. describe folding bicycles utilizing driving mechanisms of foot pedals for locomotion and suited for long distance, higher speed transportation.

### BRIEF DESCRIPTION OF THE DRAWINGS

The invention, its configuration, construction, and operation will be best further described in the following detailed description, taken in conjunction with the accompanying drawings in which:

FIG. 1 is an isometric view of the walker in a deployed position

FIG. 2 is a side view of the walker in FIG. 1. with construction shown and component parts numbered and identified below.
1 Front member
2 Rear member
3 Horizontal member
4 Seat
5 Seat post
6 Sliding bracket
7 Removable Pin
8 Handlebar
9 Handlebar stem
10 Hand brake
11 Swiveling hinge
12 Caster wheel
13 Rear wheel fork
14 Front wheel fork
15 Tube attachment
16 swivel bracket
17 Pivot brake
18 Rear pivot brake

FIG. 3 is a side view of the walker in FIG. 1 with user mounted in a walking position

FIG. 4 is a side view of the walker in FIG. 1 with user mounted in a resting position

FIG. 5 is a side view of the walker in FIG. 1 in a folded position as for storage or transport.

FIG. 6 is a side view of the walker in FIG. 1 in a folded position with folding horizontal member as an alternate embodiment.

FIG. 7 is a side view of the walker in FIG. 1 in a folded and shortened position as an alternate embodiment.

FIG. 8a is a side and top view of part 11 Swiveling Hinge.

FIG. 8b is a cross section view through section 8b-8b of the hinge component that mounts to the rear member 2.

FIG. 8c is a cross section view through section 8c-8c of the hinge component that mounts to the front member 1.

FIG. 8d is a cross section view through section 8d-8d of the hinge component that mounts to the rear member 1.

FIG. 9a is side view of caster, fork, and brake arrangement on rear member

FIG. 9b is cross section view of caster, fork, and brake arrangement on rear member

FIG. 9c is side view of caster, fork, and brake arrangement on front member

FIG. 9d is cross section view of caster, fork, and brake arrangement on front member.

FIG. 9e is side view of caster, fork, and brake arrangement on rear member using alternate embodiment of small pneumatic tires in place of caster wheels.

FIG. 9f is cross section view of caster, fork, and brake arrangement on rear member using alternate embodiment of small pneumatic tires in place of caster wheels.

FIG. 9g is side view of caster, fork, and brake arrangement on front member using alternate embodiment of small pneumatic tires in place of caster wheels.

FIG. 9h is cross section view of caster, fork, and brake arrangement on front member using alternate embodiment of small pneumatic tires in place of caster wheels.

FIG. 10a is side view and top view of handlebar assembly

FIG. 10b is side and top view of alternate embodiment of handlebar assembly

FIG. 11a is side view of seat assembly

FIG. 11b is side view and orthogonal view of seat 4

FIG. 11c is side view of seat sliding bracket 6 with orthogonal view of bracket and seat post holding fixture.

### SUMMARY OF THE INVENTION

This invention is a supportive medical walking aid for indoor use consisting of two small caster wheels located in-line with adjustable, collapsible seat and handle bars. The intended user is a person with lower extremity problems such that prolonged standing and/or walking with full weight bearing on the lower extremities is painful. Because the invention provides no lateral stabilization, the user must be capable of providing lateral stability with lower extremities. The intended application locations would be stores, shopping malls, airports and public buildings and especially areas where bicycles are prohibited but wheelchairs and walkers are allowed. The invention would allow prolonged comfortable walking, standing and resting as is required for shopping, running errands browsing about and accompanying others in similar activities. Although the invention provides relief for the user by taking body weight off the lower extremities which could be of some temporary therapeutic or rehabilitative value, the device's main use will be in allowing an afflicted person to lead a more normal life style by making chronic problems like arthritis of the knees, ankles and feet, less intrusive on lifestyle.

Locomotion is provided only by a walking action of the infirmed person. No mechanical or electrical drive mechanisms are part of this invention.

The device frame consists of a front near vertical steering member with caster wheel rotatably attached; a rear member with caster wheel rotatably attached; a horizontal member vertically pivotally attached to the rear a member and rotatably and releasably attached to the lower end of the front member. A hinge connects the top of the rear member to the front member in a manner allowing rotation of the front steering member and collapsibility when the lower horizontal member is disconnected and folded. The adjustable, collapsible seat is attached to the rear member utilizing an adjustable sliding collar. The handlebar assembly is attached adjustably to the front member utilizing a standard bicycle stem and handlebars. Seat and handlebars are adjustable in placement geometry to facilitate comfortable walking, standing and forward leaning as in easy resting. The device is collapsible and light weight for easy transport and storage. Collapsibility may be provided with both telescoping and non telescoping members. Safety brakes are provided on both front and rear casters to assist the user in safely descending ramps or generally inclined surfaces. Brake resistance is applied directly to the rubber part of the caster utilizing pull wire actuated cables attached to pivot arms which apply resistance to the wheel.

### PREFERRED EMBODIMENT

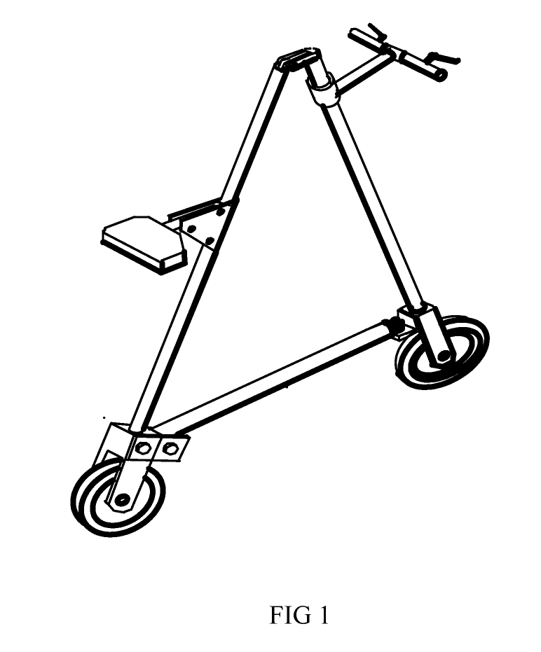

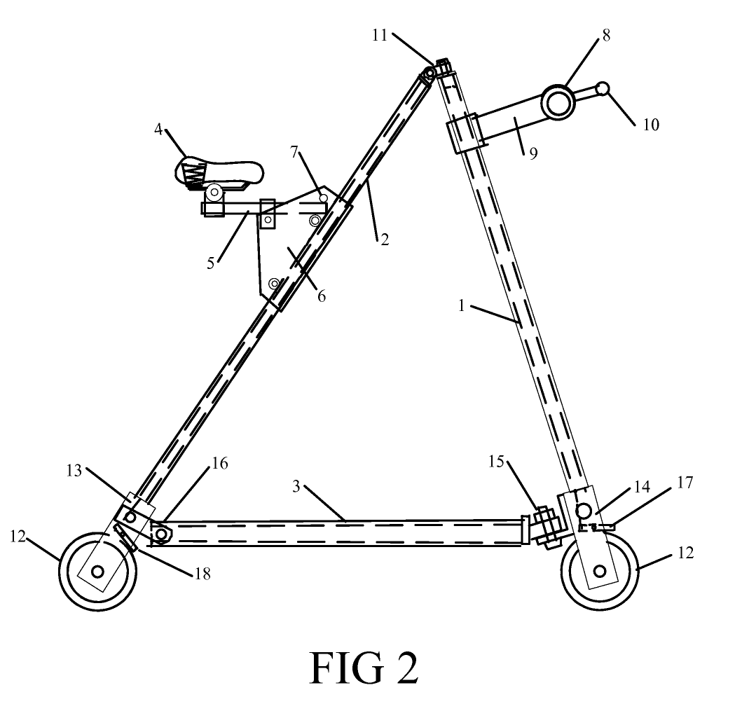

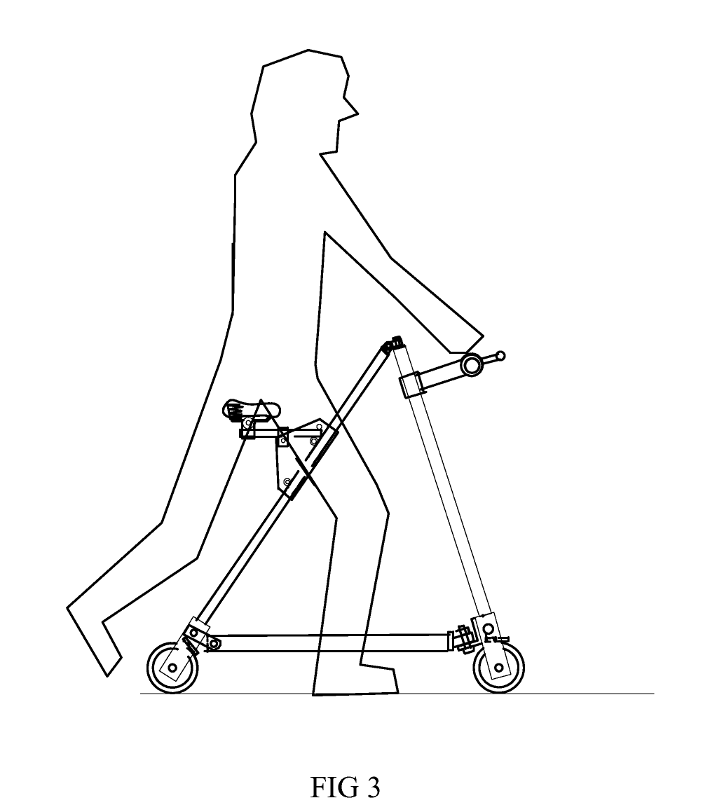

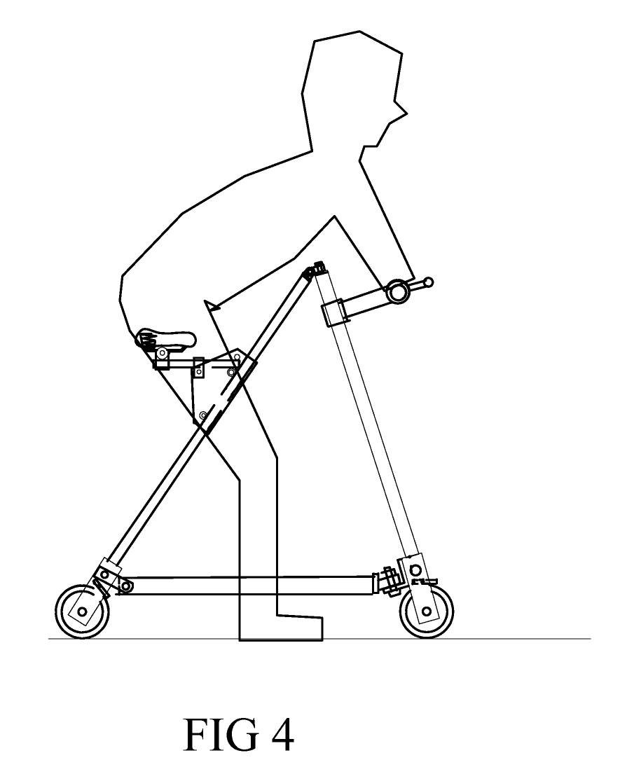

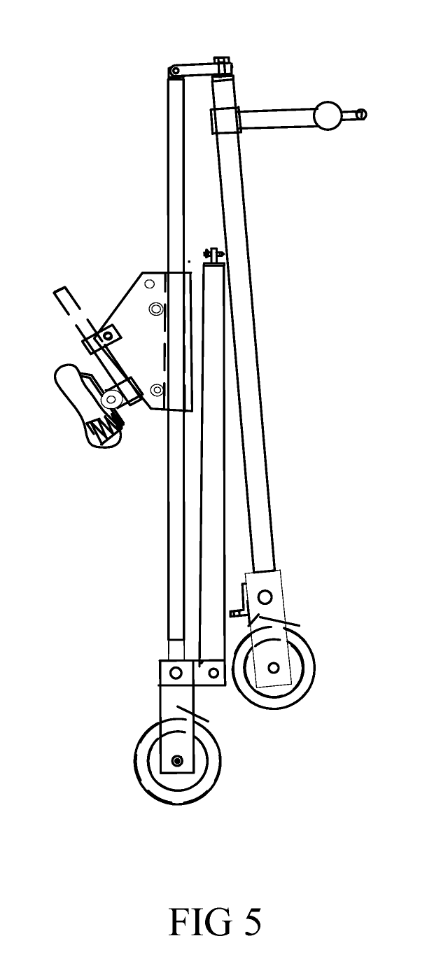

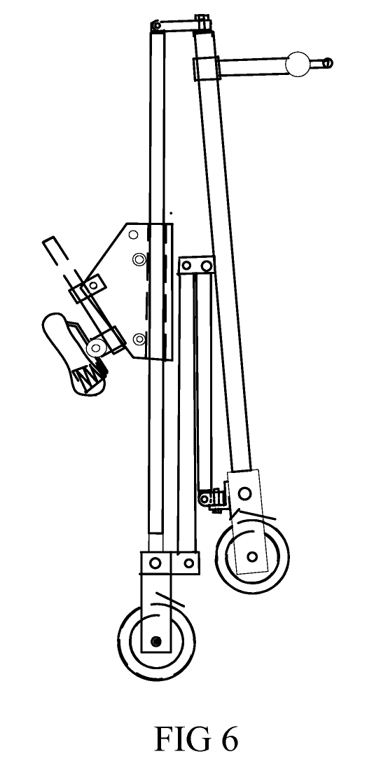

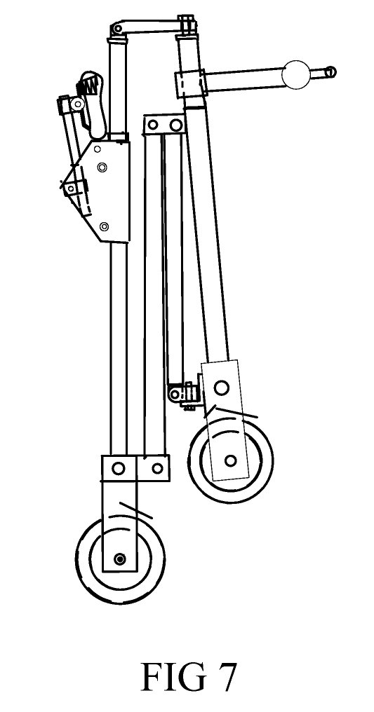

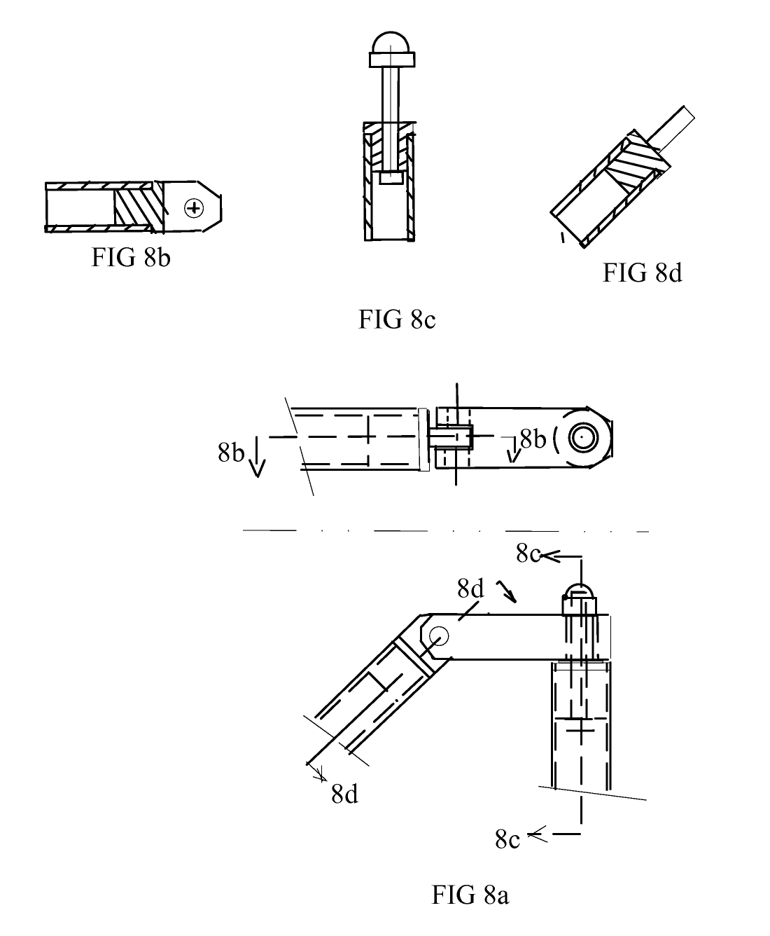

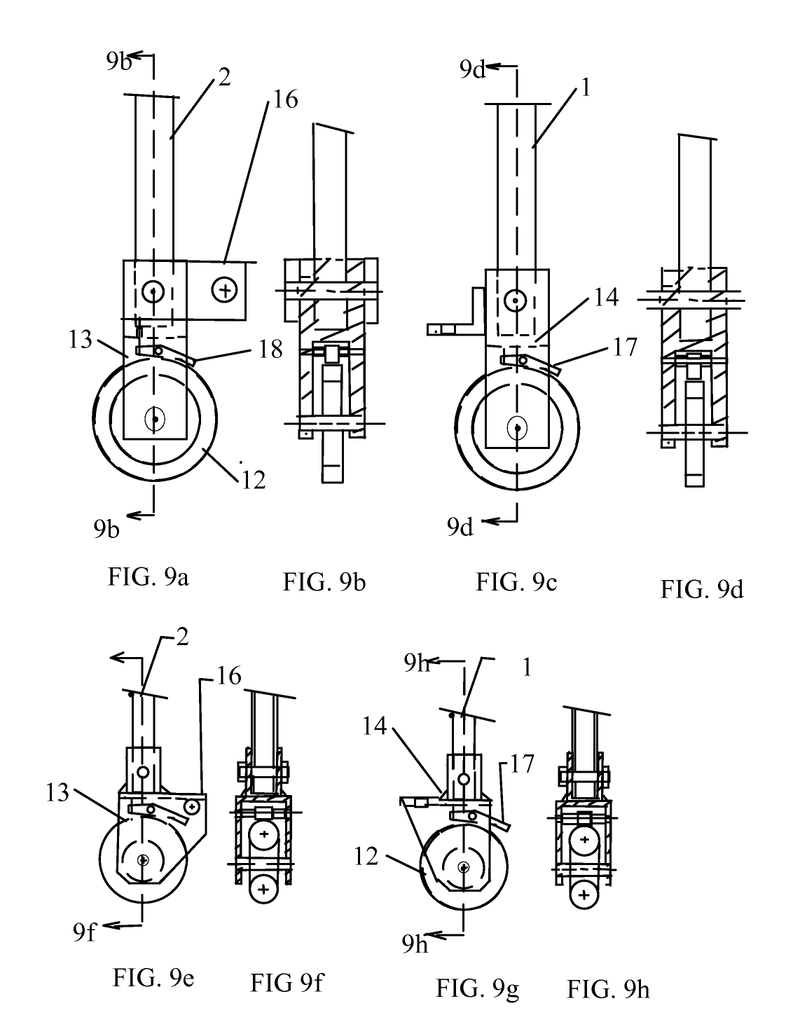

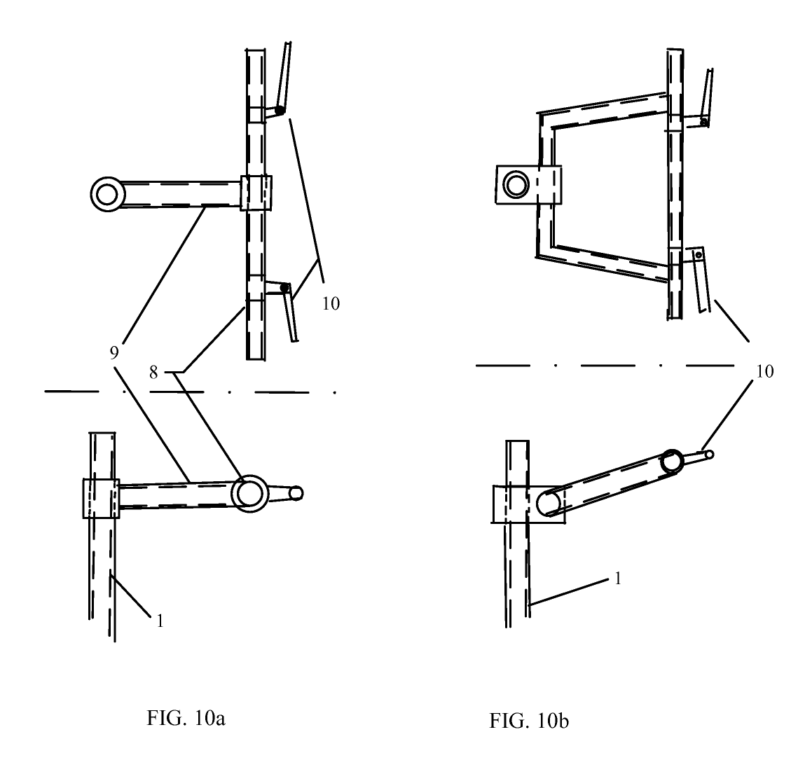

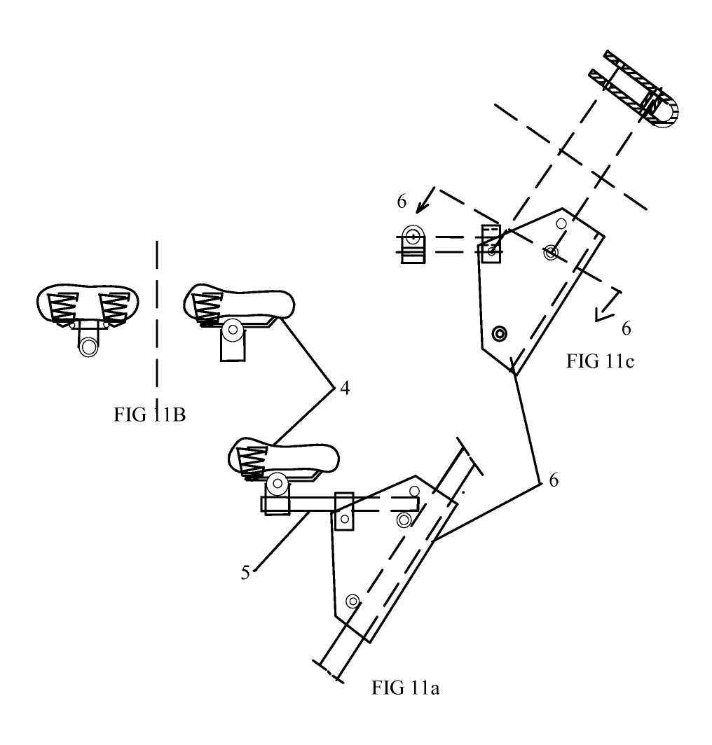

In the preferred embodiment as shown in FIG. 1 and FIG. 2, the frame consists of three members which are connected such that foldability and collapsibility are enabled. The forward member 1 is the steering member and as such is mounted so it can rotate about its longitudinal axis and has handlebar assembly and caster wheel assembly attached. The rear member 2 has the seat assembly attached and caster assembly mounted to the lower end. The horizontal member 3 connects the lower end of the front member to the lower end of the rear member. The horizontal member is pivotally mounted to the rear member and rotationally and releasably attached to the front member. Disconnecting the front of the horizontal member allows it to pivot upwards parallel to the rear member to facilitate foldability of the structure. The pivot attachment to the rear caster fork provides rotational stiffness to the rear tube, caster and seat assembly.

In the preferred embodiment, the seat 4 assembly is adjustably mounted to the rear member. Adjustment is provided in vertical height and horizontal placement to accommodate users of various heights allowing for easy walking with the seat taking the weight off the lower extremities. Vertical seat height adjustment is provided by the sliding bracket 6 which is clinched around the rear member. The seat angle may be adjustable and the distance from the rear member to the front of the seat is adjusted to provide space for comfortable accommodation of male genitalia especially in the forward leaning resting position. The seat may be wider and shorter front to rear to facilitate comfort for prolonged use. Collapsibility of the seat is provided by removing the bolt or pin 7 holding the forward end of the seat post 5 which allows downward rotation of the seat and post into contact with the rear member. To facilitate added comfort, the seat may be well padded and/or suspended on springs as are many bicycle seats.

The caster wheels 12 with very low rolling friction are desirable and embodied herein. The preferred embodiment is shown with hand brakes 10 that apply resistance directly to the outer portion of the caster through a small pivot lever 17 located at the bottom of the front and rear tubes and inside the forks 13. Baggage or handbag attachment hooks or rings may be mounted with an adjustable collar to the top of the rear member just below the swiveling hinge. The preferred embodiment includes adjustable handlebar assembly. The handlebar 8 design combined with the stem 9 design are combined to provide desirable geometry for the user relative to the hand placement for walking, standing and resting leaning forward on elbows. Because of the simple frame structure and adjustability of seat and handlebar assemblies, a large range in user size and shape may be accommodated with relatively simple and inexpensive construction options.

Alternate embodiments may be aimed at compatibility with special needs such as; use in facilities with rougher floor surfaces, use in facilities with significantly sloping surfaces, user characteristics, special lightness and compactness in traveling on airplanes and other public transportation. While aluminum may be the major structural material in tubes and components for cost considerations, titanium and composites may be attractive for use in some applications. Tubular shaped members may be most cost effective and provide alternate rotational and collapseability embodiments such as sliding collars around the steering member at bottom and top of the member.

The handlebars can be of any suitable shape and material and could be made as folding structures to facilitate compactness as in special collapsed and folded geometry for carrying on an airplane. Folding or telescopically collapsing of the major members may also be used for compactness.

Other forms of slidably adjustable seats may also be utilized. A variety of seats may be used depending on user characteristics such as gender, size, and weight.

Other wheels may also be used such as pneumatic tires to increase comfort on rougher surfaces than are anticipated by the preferred embodiment.

Other forms of braking including discs, drums or pads may also be utilized in conjunction with other small caster and wheel applications if heavier duty applications are desired.

It is noted that the embodiment of the two-wheeled in-line walker described herein in detail for exemplary purposes is subject to many variations in structure, design, application and methodology as may become apparent to those skilled in the art without departing from the spirit and scope of the invention. Therefore, included within the patent warranted heron are all such changes and modifications as may reasonably and properly be included within the scope or this contribution to the art.

1. A two wheeled, in-line supportive medical walker comprising: a triangular frame consisting of a front near vertical steering member, a rear near vertical member and a lower supporting horizontal member; a small caster wheel rotatably attached to the lower end of front frame member; a small caster wheel rotatably attached to the rear member; a handlebar assembly attached to the front member; a collapsible moveable seat assembly attached to the rear member.

2. A two wheeled walker as recited in claim 1 wherein said front member is rotatably attached to said rear member by a hinging fixture allowing collapse of the front member parallel to said rear member when said horizontal supporting member is disconnected or folded.

3. A two wheeled walker as recited in claim 1 wherein said front steering member is fitted with moveable handlebar assembly consisting of mounting stem and handlebar allowing positioning to provide operator comfort in walking position, standing position, and leaning forward on elbows as in resting position.

4. A two wheeled walker as recited in claim 1 wherein said seat assembly attached to said rear member consisting of a slideable constrictable collar supporting said collapsible seat and said seat mounting post to provide proper seat to ground distance for operator leg action which provides locomotion forces and lateral stability.

5. A two wheeled walker as recited in claim 1 wherein said horizontal support member is fitted on the forward end with quick disconnect mechanism allowing attachment to the front steering member in a rotatable fashion and attached to the rear member in pivotal manner allowing said horizontal member to pivot upwards into a position parallel to said front and rear members in a collapsed mode.

6. A two wheeled walker as recited in claim 1 wherein; said front steering member is fitted on lower end with caster wheel mounting fork assembly; said rear member is fitted on lower end with caster wheel mounting fork assembly with forward protruding ears to facilitate pivotal attachment of said horizontal member and provide positive alignment and stability of said rear member and seat assembly.

7. A two wheeled walker as recited in claim 1 wherein; said front steering member is fitted on the lower end with a caster wheel; said rear member is fitted on the lower end with a caster wheel.

8. A two wheeled walker as recited in claim 6 wherein; said front member is fitted with a safety brake assembly consisting of a pull cable actuated pivot arm with forward end of said pivot arm forced to interfere with said caster to provide braking of the walker; said rear member is fitted with a safety brake assembly consisting of a pull cable actuated pivot arm with forward end of said pivot arm forced to interfere with said caster to provide braking of the walker.
